(19) United States
(12) Patent Application Publication
(10) Pub. No.: US 2011/0299897 A1
(43) Pub. Date: Dec. 8, 2011

(54) IMAGE FORMING APPARATUS AND CLEANING METHOD

(75) Inventors: Masahiro ONODERA, Tokyo (JP); Toshiki HAYAMI, Tokyo (JP)

(73) Assignee: KONICA MINOLTA BUSINESS TECHNOLOGIES, INC., Tokyo (JP)

(21) Appl. No.: 13/115,574

(22) Filed: May 25, 2011

(30) Foreign Application Priority Data
Jun. 2, 2010 (JP) 2010-126607

(51) Int. Cl. G03G 15/20

(52) U.S. Cl. 399/327

(57) ABSTRACT

An image forming apparatus, capable of cleaning a fixing member by conveying a blank sheet, including: an image forming section for forming a toner image on a sheet; a feeding section for feeding a sheet to the image forming section; a fixing section for fixing a toner image onto a sheet at a nip formed between a fixing member and a pressure member; and a control section for controlling the image forming section and the fixing section to feed a sheet from the feeding section, wherein, when a toner is adhered to a fixing section, the control section controls to feed a sheet from the feeding section, convey to the fixing section without forming a toner image thereon, and transfer a toner, having been adhered onto the fixing member, onto a downstream side of the sheet from a leading edge area of the sheet in a sheet conveying direction.

This application is based on Japanese Patent Application No. 2010-126607 filed on Jun. 2, 2010 with the Japanese Patent Office, the entire content of which is hereby incorporated by reference.

### TECHNICAL HELD

The present invention related to an image forming apparatus and a cleaning method using an electro-photographic method, particularly relates to an image forming apparatus and a cleaning method, capable of outputting high quality image steadily by removing toner stain caused at fixing section.

### BACKGROUND OF THE INVENTION

Recently, applications of the above-mentioned image forming apparatus have expanded from the office field to printing field. Color image forming has also become widespread. In those applications, an image forming apparatus, capable of providing high quality images over a long period of time, is required to be provided. More particularly, countermeasures against abrasion and minor damage of fixing member have been stringently required more and more.

Because of these factors, an image forming apparatus has been suggested in which, when a toner stain occurs on a fixing member due to a paper jam, or the like, a blank sheet of paper is passed through the fixing section to clean the fixing member, without providing a cleaning mechanism in which a cleaning member is pressed into contact with a fixing member to clean the fixing member (Unexamined Japanese Patent Application No. 2003-98888 (hereinafter referred to as Patent Document 1), and No. 2004-45579 (hereinafter referred to as Patent Document 2)).

An image forming apparatus, described in Patent Document 1, includes a fixing means composed of a fixing roller and heating roller as fixing members, and, in a case in which there is a possibility that a sheet of paper is sandwiched at a nip of the fixing means when a paper jam occurred, an operation mode to clean the fixing member is carried out by passing a sheet of paper on which no image has yet been formed (a blank sheet of paper) through the nip, before a resumption of print after jam treatment, to transfer the adhered residual toner, on the surface of the fixing member, onto the blank sheet of paper so as to remove and recover the residual toner from the fixing member. Consequently, troubles at resumption of image forming (image contamination, staining of the rear face of the sheet of paper, and paper wrapping around fixing member), caused by the toner stain on fixing member at the occurrence of a paper jam, are prevented from occurring.

An image forming apparatus, described in Patent Document 2, includes a means for detecting a paper jam occurred in a fixing device, and, in a case in which a paper is stuck (a paper jam) in a fixing device, more than or equal to one sheet of paper, aside from a sheet of paper for printing data, is automatically fed to the fixing device, after the jammed paper is removed by the user, so as to remove the residual toner adhered onto fixing member, caused by the paper jam. Also, the apparatus is provided with a stain detection means for detecting toner adhered onto the surface of a fixing member, and when toner adhered on the surface of fixing member is detected via the stain detection means, one or more sheets of paper, aside from the sheets of paper for printing data, is automatically passed through the fixing device, regardless of existence of a paper jam or not, so as to remove the toner adhered onto the fixing member.

The image forming apparatuses, described in Patent Documents 1 and 2, are capable of preventing image quality problems, caused by toner stain on a fixing member, from occurring, without being equipped with a cleaning mechanism in a fixing device, by passing one sheet of paper forcibly after jam treatment, or a plurality of sheets of papers as appropriate, without an image thereon, through the fixing device.

However, the problem of paper wrapping in which a sheet of paper (blank sheet of paper), for cleaning purpose, is wrapped around the fixing member, could not be sufficiently solved. Although it could be considered to provide a paper separation mechanism, particularly, a separation claw which contacts the fixing member, to prevent the paper wrapping from occurring, the provision of a paper separation mechanism was problematic because of scuffing due to the separation claw, and unevenness of gloss due to the scuffing, and unevenness of gloss due to the contact of the separation claw with the surface of a sheet of paper, and the like, were consequent problems.

After reviewing in detail the phenomenon of wrapping of a sheet of paper (blank sheet of paper) for cleaning purpose, it was discovered that the paper wrapping at fixing member occurs under the following conditions.

Condition 1: If a sheet of paper is passed through the nip portion in such a manner that the leading edge of the sheet of paper overlaps the area of the fixing member where the toner stain exists, paper wrapping occurs.

Condition 2: As the area of toner stain, facing the leading edge or leading edge area of a sheet of paper, grows larger, the frequency of paper wrapping increases.

Condition 3: As the density of toner stain increases even if the area is the same, the frequency of paper wrapping increases.

### SUMMARY OF THE INVENTION

The present invention has been achieved in consideration of the above problems, and to provide an image forming apparatus and a cleaning method capable of cleaning toner stain on a fixing member, without paper wrapping, by feeding of a blank sheet of paper.

To achieve at least one of the above-stated objects, an image forming apparatus reflecting one aspect of the present invention including: an image forming section for forming a toner image on a sheet of paper, a feeding section for feeding a sheet of paper to the image forming section; a fixing section for fixing a toner image onto a sheet of paper by sandwiching and conveying the sheet of paper, onto which a toner image has been formed, at a nip which comprises a fixing member and a pressure member which is pressed into contact with the fixing member; and a control section for controlling, in a case in which an image is formed on a sheet of paper, the feeding section, the image forming section, and the fixing section so as to feed a sheet of paper from the feeding section, to form a toner image on the sheet of paper via the image forming section, and to fix the toner image on the sheet of paper via the fixing section, wherein, in a case in which a toner is adhered to a fixing section without complete fixing of a toner image onto a sheet of paper, the control section is configured to control to feed a sheet of paper from the feeding section, and convey the sheet of paper to the fixing section without forming a toner image on the sheet of paper via the image forming section, and transfer a toner, having been adhered onto the fixing member, onto a downstream side of the sheet of paper from a leading edge area of the sheet of paper in a direction in which sheet of paper is conveyed.

To achieve at least one of the above-stated objects, a cleaning method, reflecting one aspect of the present invention, of an image forming apparatus, the apparatus including: an image forming section for forming a toner image on a sheet of paper; an image forming section for forming a toner image on a sheet of paper; a feeding section for feeding a sheet of paper to said image forming section; and a fixing section for fixing a toner image on a sheet of paper, onto which the toner image has been formed, by sandwiching and conveying the sheet of paper via a nip which comprises a fixing member and a pressure member which is pressed into contact with said fixing member; wherein the cleaning method comprises steps of feeding a sheet of paper, conveying the sheet of paper, having been fed, without carrying out image formation via the image forming section; releasing the nip of the fixing section and passing the sheet of paper through; and forming the nip after a leading edge of the sheet of paper has passed though the fixing section, and sandwiching and conveying the sheet of paper via the nip, having been formed.

### BRIEF DESCRIPTION OF THE DRAWINGS

The preferred embodiments of the present invention are shown by way of example, and not limitation, in the accompanying figures, in which:

FIG. 1 is a diagram schematically showing an image forming apparatus according to an embodiment of the present invention.

FIG. 2 is an enlarged cross-sectional diagram schematically showing fixing section 30 according to an embodiment of the present invention.

FIG. 3 is a cross-sectional diagram schematically showing a pressure contact release mechanism of an outer pressure roller against fixing belt 31.

FIG. 4 is a block diagram schematically showing a fixing member cleaning control according to an embodiment of the present invention.

FIG. 5 is a flow chart showing the transition to a flow of a fixing belt cleaning control when a paper jam occurred.

FIG. 6 is a flow chart showing a first embodiment related to a “fixing belt cleaning control”.

FIG. 7 is a state diagram schematically showing time frame for blank sheet of paper P to pass through the principle parts of fixing section 30, and ON time of pressure contact mechanism to form nip N in a case in which “fixing belt cleaning control” is carried out.

FIG. 8 is a block diagram schematically showing a control for fixing belt cleaning according to a second embodiment.

FIG. 9 is a flow chart showing fixing member cleaning control according to the second embodiment of the present invention.

FIG. 10 is a flow chart showing a control to determine a paper feed cassette to be used for blank sheet feeding.

### DETAILED DESCRIPTION OF TILE PREFERRED EMBODIMENTS

The preferred embodiments of the present invention are described below. However, the descriptions given here shall not limit the technical scope of the claims or the definitions of terms. Further, the definitive explanations in the preferred embodiment of the present invention below are only indicative of the best mode and shall not limit in any way the meanings of terms or the technical scope of the present invention.

### [Image Forming Apparatus of an Electro-Photographic Method]

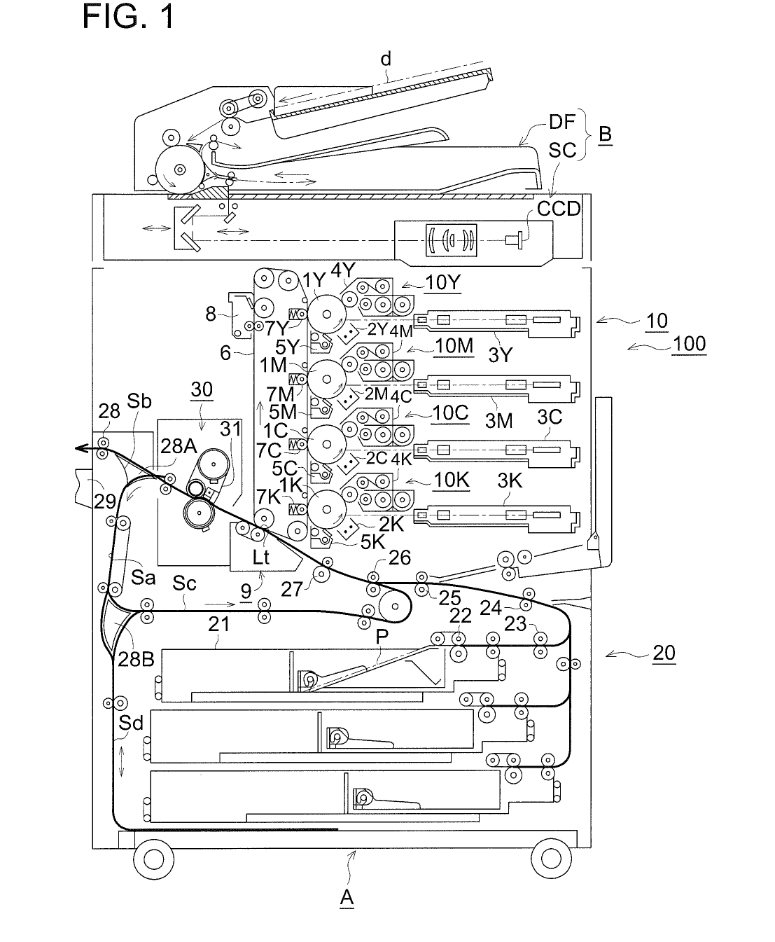

FIG. 1 is a diagram schematically showing image forming apparatus A according to an embodiment of the present invention.

Image forming apparatus A is provided with image reading apparatus B placed above image forming apparatus A.

Image forming apparatus A is a so called tandem method color image forming apparatus which is composed of a plurality of sets of image forming devices 10Y, 10M, 10C, and 10K, image forming section 100 which includes intermediate transfer belt 6 as an image bearing member according to an embodiment of the present invention, paper feeding section 20, and fixing section 30, and the like.

Above image forming apparatus A, image reading apparatus B, which is composed of automatic document feeder DF and document image scanning exposure unit SC, is placed. Document d, placed on the document table of automatic document feeder DF, is conveyed by the document conveying means, and the image on one side or both sides of the document is scanned and exposed by the optical system of document image scanning exposure unit SC, and is read in by line image sensor CCD.

Image signals are generated through a photoelectric conversion via line image sensor CCD, subjected to an analog processing, an A/D conversion, a shading compensation, an image compression processing, and the like, at an image processing section, and thereafter sent to exposing sections 3Y, 3M, 3C, and 3K.

Image forming device 10Y, that forms a yellow (Y) color image, includes charging electrode 2Y, exposure section 3Y, developing section 4Y, and cleaning section 5Y arranged around the periphery of photoconductor 1Y. Image forming device 10M, that forms a magenta (M) color image, includes charging electrode 2M, exposure section 3M, developing section 4M, and cleaning section 5M arranged around the periphery of photoconductor 1M. Image forming device 10C, that forms a cyan (C) color image, includes charging electrode 2C, exposure section 3C, developing section 4C, and cleaning section 5C arranged around the periphery of photoconductor 1C. Image forming device 10K, that forms a black (K) color image, includes charging electrode 2K, exposure section 3K, developing section 4K, and cleaning section 5K arranged around the periphery of photoconductor 1K. Charging electrode 2Y and exposure section 3Y, charging electrode 2M and exposure section 3M, charging electrode 2C and exposure section 3C, and charging electrode 2K and exposure section 3K each constitute a latent image forming means.

Meanwhile, developing sections 4Y, 4M, 4C, and 4K each contain two-component developing agent consisting of a small-particle toner of yellow (Y), magenta (M), cyan (C), and black (K), and a carrier, respectively.

Intermediate transfer body 6 is wound around a plurality of rollers, and is supported by a driving section, which in not illustrated, in a rotatable manner.

Fixing section 30 fixes the unfixed toner image, on sheet of paper P at nip N, which is formed between heated fixing member (referred to as a fixing belt) 31 and pressure member (referred to as an outer pressure roller) 33, by heat and pressure.

The toner used in the above-stated embodiment contains an amount of an off-set inhibitor of 10 mass parts in 100 mass parts of a resin.

Because the off-set inhibitor is a low molecular mass compared with the main resin of toner, and also has a low melting point, the off-set inhibitor is caused to be in a molten state, different from the main resin which remains in a state of viscous elasticity, when passing through nip N of the fixing section, spreads out in such a manner that it covers the surface of the toner layer, and occupies the surface boundary between the toner layer and the surface layer of fixing belt 31, so as to make it possible to increase dramatically the releasing property of the toner layer to the surface layer of fixing belt 31. Here, a wax made of a low molecular weight polypropylene is used as the off-set inhibitor.

The toner images of each color, having been formed by image forming devices 10Y, 10M, 10C, and 10K on photoconductor 1Y, 1M, 1C, and 1K, respectively, are successively transferred onto intermediate transfer body 6 which is an image bearing member according to preferred embodiments of the present invention, via primary transfer sections 7Y, 7M, 7C, and 7K, whereby the toner images, consisting of each color, are formed on intermediate transfer body 6.

Sheet of paper P stored in paper feed cassette 21 of paper feeding section 20 is fed out by feed roller 22, and conveyed to secondary transfer section 9 through feed rollers 23, 25 and 26, and registration roller 27. The toner images, having been formed via secondary transfer section 9 on intermediate transfer body 6, are transferred onto sheet of paper P via sheet transfer section Lt.

Sheet of paper P, onto which the toner images have been transferred, is separated from intermediate transfer body 6 via so called “curvature-separation” and “curvature-release”, and conveyed to fixing section 30. Then, the toner images on sheet of paper P is fixed by applying heat and pressure. After that, sheet of paper P is gripped by paper exit roller 24 and ejected onto sheet discharge tray 29.

Meanwhile, the area of intermediate transfer body 6, onto which the toner images were formed, reaches cleaning section 8 after the toner images were transferred onto sheet of paper P via secondary transfer section 9, and any residual toner on the area of intermediate transfer body 6 is removed via cleaning section 8, and intermediate transfer body 6 is cleaned again back to the state in which intermediate transfer body 6 is ready for image formation.

When sheet of paper P, on which the toner image has been fixed, is to be ejected in a reverse ejection mode, sheet of paper P is passed through a conveyance path located on the right side in the figure, of branching plate 28A, which is placed between fixing section 30 and ejection rollers 28, and conveyed downward to first conveyance path Sa. After sheet of paper P is conveyed to first conveyance path Sa, then sheet of paper P is subjected to switchback and passed through second conveyance path Sb, located on the left side, in the figure, of branching plate 28A, and ejected outside the apparatus via ejection rollers 28.

When toner images are to be copied on the both surfaces of sheet of paper P, after the toner image, formed on the front surface of sheet of paper P, has been fixed via fixing section 30, sheet of paper P is conveyed to sheet transfer section Lt through double surface conveyance path S which is composed of first conveyance path Sa, fourth conveyance path Sd, and third conveyance path Sc. Then, sheet of paper P is reversed while sheet of paper P is being conveyed through double surface conveyance path S.

After fixing the image on the first surface of sheet of paper P, this sheet of paper P is conveyed through first conveyance path Sa, and further conveyed through fourth conveyance path Sd which is located downstream of branching plate 28B, and then conveyed backward and reversed. Sheet of paper P, having been reversed, is passed through a conveyance path, located on the right side in the figure, of branching plate 28B, and conveyed through third conveyance path Sc, and then turned upward to be conveyed to sheet transfer section Lt via feed roller 26.

Then, the color image, formed on intermediate transfer body 6, is transferred to the second surface of sheet of paper P at sheet transfer section Lt so as to form the color image on the second surface of sheet paper of P. Further, sheet of paper P is heated and pressed via transfer apparatus 30 so that the color image is fixed, and then, is ejected outside the apparatus via ejection rollers 28.

### [Fixing Section]

Now, fixing section 30, placed on top of image forming apparatus A, according to an embodiment of the present invention, will be described.

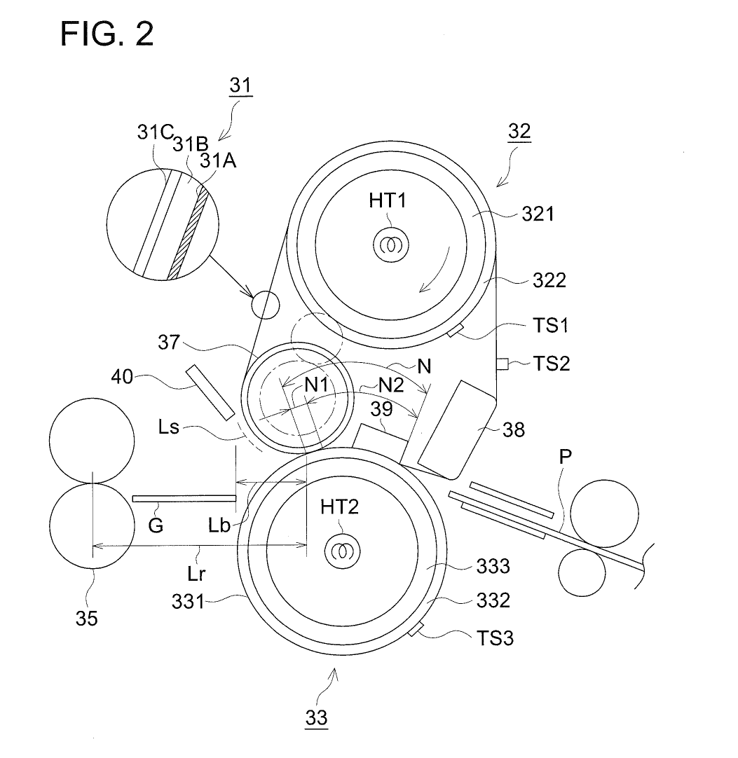

FIG. 2 is an enlarged cross-sectional diagram schematically showing fixing section 30 according to an embodiment of the present invention.

The fixing method of fixing section 30, shown in FIG. 2, is that sheet of paper P is pressed into contact with fixing belt 31 as a heated fixing member via nip N so as to be heated to fix the toner image onto sheet of paper P.

Nip N of fixing section 30 consists of fixing belt 31, which rotates, and outer pressure roller 33, which works as a pressure member pressed into contact with fixing belt 31, and conveys sheet of paper P, which has been fed from feeding section 22 and a toner image has been formed thereon via sheet transfer section Lt, while being sandwiched and pressed, so as to fix the toner image.

Nip N consists of main nip N1, which is composed of supporting pressure roller 37 and outer pressure roller 33 which is pressed into contact with supporting roller 37, and auxiliary nip N2, which is located upstream of main nip N1 in the rotational direction of fixing belt 31, and is the area where fixing belt 31 is pressed, via pressure pad 39, into contact with outer pressure roller 33, while being pressed around outer pressure roller 33.

Nip N of fixing section 30 is formed over a wide range in a direction in which a sheet of paper is conveyed, as shown in FIG. 2. The toner image on sheet of paper P is fixed on sheet of paper P by strong pressure via main nip N1, after the toner image, together with sheet of paper P, is provided with sufficient heat from fixing belt 31 while passing through wide auxiliary nip N2.

Supporting pressure roller 37 is pressed into contact with outer pressure roller 33 at a force of 200 to 800 N via a pressure means, which will be described later.

Fixing belt 31 is composed of a) base 31A which is preferably of A4 width and is extended with a tensile force of 10 to 100N, and is made of a material of high heat resistance and durability and less morphological history due to extension, b) intermediate layer 31B which is made of a heat-resistant rubber formed on base 31A, and c) surface releasing layer 31C which is made of a low surface energy resin coated on the surface of intermediate layer 31B. In this embodiment, polyimide of a thickness of 90 μm serving as base 31A, silicon rubber of a thickness of 200 μm serving as intermediate layer 31B, and PFA (tetrafluoroethylene perfluoroalkyl vinyl ether copolymer), or PTFE (polytetrafluoroethylene), of a thickness of 30 μm serving as surface releasing layer 31C, are used. These materials are not limited to this embodiment, and it is possible that these materials can be composed of other heat-resistance materials

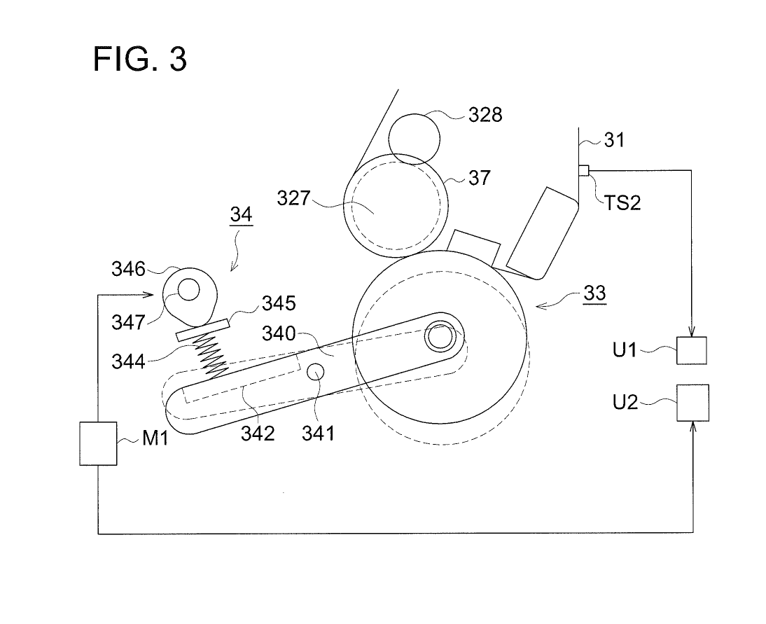

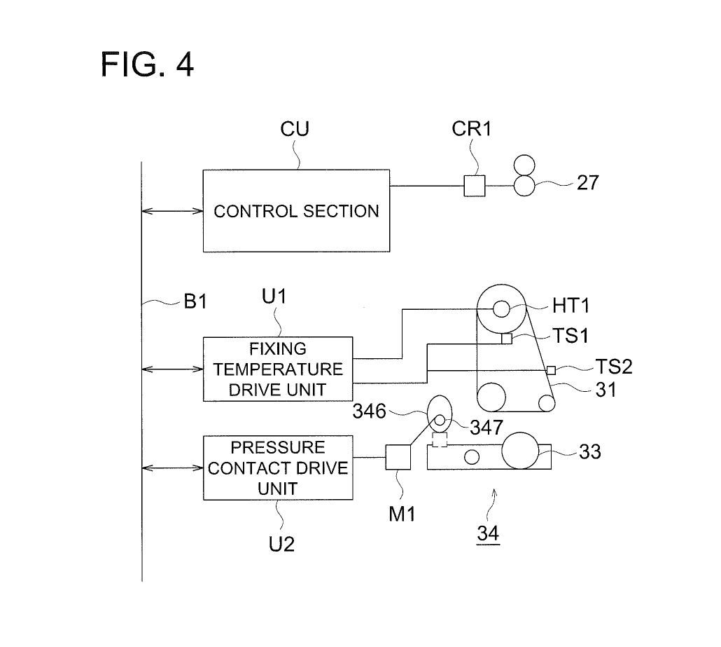

Supporting heat roller 32 is composed of a cylindrically-shaped metal core 321, formed of aluminum, of which the outer circumference is covered by releasing layer 322, and is heated to a predetermined temperature via halogen heater HT1 which serves as a heat source and disposed in hollow of supporting heat roller 32. Roller temperature sensor TS1, shown in the figure, detects the temperature of supporting heat roller 32, and outputs the detected result to fixing temperature drive unit U1 (refer to FIGS. 3 and 4). Fixing temperature drive unit U1 controls the power distribution to halogen heater HT1 so as to maintain the temperature of supporting heat roller 32 at a prescribed temperature.

Also, belt temperature sensor TS2, which is disposed upstream of fixed block 38, which extends fixing belt 31, detects the temperature of fixing belt 31 just before nip N. A control section, which is not illustrated, activates halogen heater HT1 by changing a reference temperature of roller temperature sensor TS1 as appropriate based on the output of belt temperature sensor TS2, and controls the temperature of fixing belt 31 with a high degree of accuracy.

Fixing belt 31 is heated to a temperature in the range of 160 to 200° C. in accordance to the gloss level and the thickness of sheet of paper P.

Outer pressure roller 33 is composed of cylindrically-shaped metal core 333, formed of aluminum, of which the outer circumference is covered by heat-resistant layer 332, which is made of an elastic body, and the outer circumference heat-resistant layer 332 is covered by surface releasing layer 331. Halogen heater HT2, which serves as a heat source, is disposed in hollow of outer pressure roller 33, and outer pressure roller 33 is heated by the activation of halogen heater HT2. Contact-type temperature sensor TS3 detects the temperature of outer pressure roller 33, and outputs the detected result to fixing temperature drive unit U1. Fixing temperature drive unit U1 controls the power distribution to halogen heater HT2 so as to maintain the temperature of outer pressure roller 33 at a prescribed temperature.

Because surface releasing layer 31C, which is thin, of heated fixing belt 31 is pressed firmly at nip N, following the unevenness of the toner layer and sheet of paper P, via compressive deformation of intermediate layer 31B, the toner image is evenly heated and fixed onto sheet of paper P. Thus, a high quality image is faulted, with a toner image which has a moderately-evened gloss, on fixed sheet of paper P.

The leading edge of sheet of paper P, being discharged from nip N, is separated assuredly from fixing belt 31 when it has reached sheet separation section Ls of fixing belt 31, and sheet of paper P is conveyed along with discharge guide G, sandwiched and conveyed via fixing section ejection rollers 35 and ejected outside the apparatus.

Supporting pressure roller 37 doubles as a separation roller, and also equipped with separation facilitating section 40. Separation facilitating section 40 functions to separate a sheet of paper from fixing belt 31, the sheet of paper which could not be separated via separation roller 37. Separation facilitating section 40 may be constituted via a configuration in which a plurality of separation claws, or the like, adjacent to fixing belt 31, which rotates, are disposed in the width direction, perpendicular to the direction of the rotation, or by a plate-like member.

FIG. 3 is a cross-sectional diagram schematically showing pressure contact release mechanism 34 of outer pressure roller 33 against fixing belt 31.

In FIG. 3, outer pressure roller 33 is supported by roller supporting plates 340 at the front side and rear side of the roller via a heat-resistant sleeve, which is not illustrated. Each roller supporting plate 340 is rotatable around supporting shaft 341, as a supporting point, which is supported by a frame of fixing section 30. The position of outer pressure roller 33 is changeable between a pressure contact position, where nip N is formed as shown in a solid line, and a release position, where nip N is released, shown in dotted-line.

Pressure contact release mechanism 34, which forms nip N or releases the nip, consists of a) supporting plate 340, which rotatably supports outer pressure roller 33, b) supporting shift 341 which is supported by the frame of fixing section 30 and rotatably supports supporting plate 340 by being support via the frame of fixing section 30, c) spring 344, which forces protrusion 342 of supporting plate 340, d) cam 346 which controls the force to supporting plate 340, via spring 344, by switching the position of reference plate 345 of spring 344, and e) pressure contact release motor M1 which rotates cam 346.

When image forming apparatus A is in operation, or in a period of preparation for operation, pressure contact release motor M1, which is linked with cam shaft 347, is controlled to switch the state of cam 346 to the state of pressure contact, to press outer pressure roller 33 into contact with supporting pressure roller 37, and to press outer pressure roller 33 into contact with fixing belt 31, so as to form nip N of fixing section 30.

When image forming apparatus A is at the time of shut down, or when a paper jam has occurred, pressure contact release mechanism 34 is controlled to switch the state of cam 346 to the state of release so as to release nip N of fixing section 30.

Note that, in the explanations below, the area where fixing belt 31 and supporting pressure roller 33 are opposite each other is referred to as nip N even in cases in which nip N of fixing section is released via pressure contact release mechanism 34.

Also, supporting pressure roller 37 is rotated by the force of a driving section which is not illustrated. Gear 32 is linked to the driving section, and engaged with gear 327 which is fixed firmly to supporting pressure roller 37, as shown in FIG. 3.

Next, fixing belt cleaning control, according to an embodiment of the present invention, to clean toner stains of fixing belt 31, will now be described.

FIG. 4 is a block diagram schematically showing the fixing belt cleaning control according to this embodiment of the present invention.

Reference symbol CU denotes a control section which controls the entire image forming apparatus A, and also executes fixing belt cleaning control according to the embodiment of the present invention. Here, main configurations related to fixing belt cleaning control are described, and configurations such as the image forming section, and the like, which are not related, are omitted.

Reference symbol CR1 denotes a clutch which is disposed in a drive transfer system, which is not illustrated, and is controlled via control section CU so as to switch the operation state of registration roller 27, of feeding section 20, between an operative and an inoperative state.

Reference symbol U1 denotes a fixing temperature drive unit which controls the activation of halogen heater HT1 which controls the temperature of fixing belt 31. Fixing temperature drive unit U1 also controls the temperature of outer pressure roller 33, of which related explanations are omitted.

Reference symbol U2 denotes a pressure contact drive unit which operates pressure contact release mechanism 34 of the outer pressure roller against fixing belt 31 which is being extended. Pressure contact drive unit U2 controls the rotation of pressure contact release motor M1 which is linked to cam shaft 347 which supports cam 346.

### [Embodiment of Fixing Belt Cleaning Control]

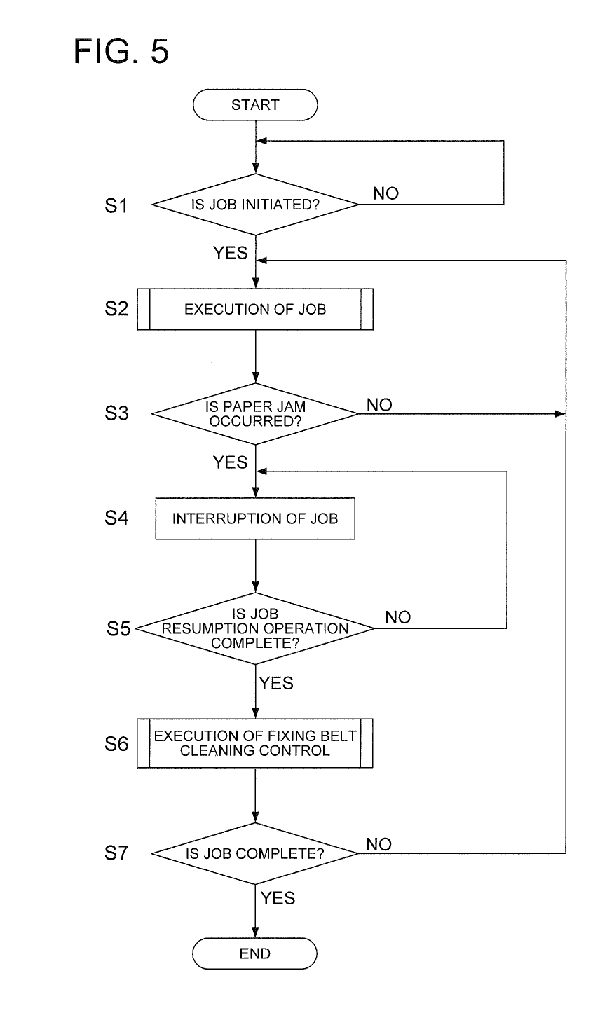

FIG. 5 is a flow chart showing the transition to a flow of the fixing belt cleaning control when a paper jam occurred.

When a job execution-command is issued (step S1), the job for image formation is executed (step S2). Then, if a paper jam occurs while the job is being executed (step S3), the job is interrupted (step S4), and when jam treatment has been carried out and operations for job resumption has been carried out by the operator (step S5), “fixing belt cleaning control” is executed (step S6). Then, when “fixing belt cleaning control” has been completed, if there is an interrupted job (S7: NO), the interrupted job is resumed, and if there in no interrupted job (S7: YES), the flow is complete (END).

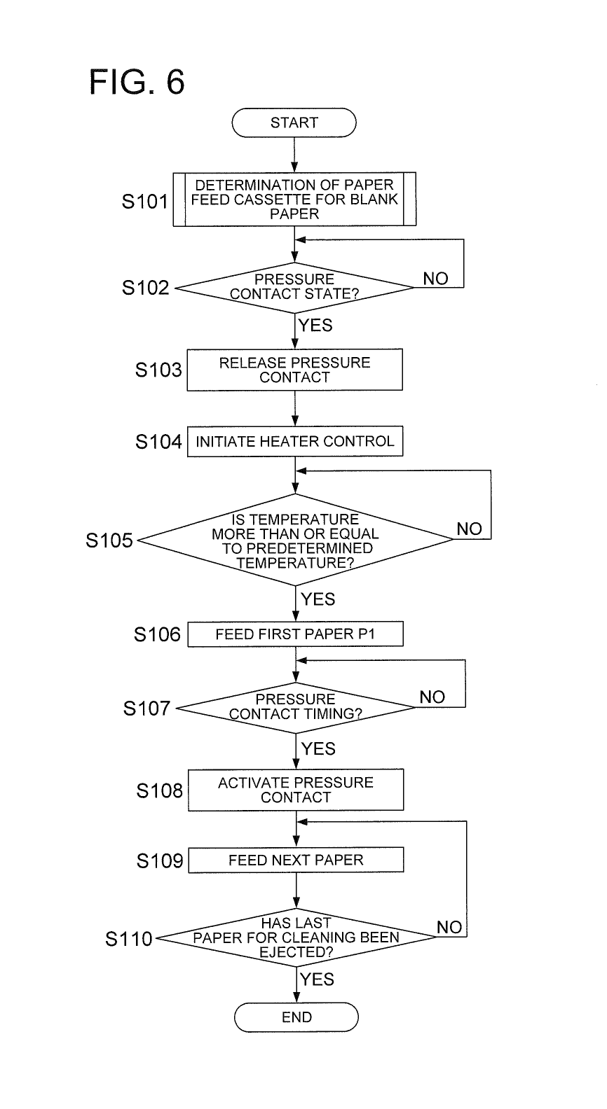

FIG. 6 is a flow chart showing a first embodiment related to “fixing belt cleaning control”.

Fixing belt cleaning control, according to the preferred embodiments of the present invention, will now be briefly described.

Fixing belt cleaning control, according to the preferred embodiments of the present invention, does not require specific parts for exclusive use, and it falls into the category of technology in which, when a toner stain is detected on fixing belt 31, or when it is assumed that a toner stain may occur on fixing belt 31, sheet of paper P is fed from paper feed cassette 21 via feeding section 22 while fixing belt 31 is heated to a prescribed temperature, and sheet of paper P is conveyed via nip N as a blank sheet of paper without transferring toner image at sheet transfer section Lt, and the fixing belt is cleaned by transferring the toner stain on fixing belt 31 onto sheet of paper P.

While sheet of paper P is passed through nip N, the same area of fixing belt 31 goes around nip N for a plurality of number of times. Therefore, toner stain on fixing belt 31 can be cleaned assuredly by passing one to plural numbers of sheet of papers P through nip N.

Further, the fixing belt cleaning control is to prevent “wrapping of a sheet of paper around fixing belt 31”, which tends to occur when leading edge area Pfa of sheet of paper P is overlapped on the area of toner stain on fixing belt 31 while passing through nip N, from being occurred.

The control (flow chart) of FIG. 6 will now be described.

Step S101 is a step to determine sheet of paper P1 to be used for “fixing belt cleaning control”. In other words, it is a step to determine an appropriate paper feed cassette 21 from a plurality of paper feed cassettes 21. An example of step S101 will be described later.

Step S102 is a step to determine whether or not nip N of fixing section 30 is in a state of pressure contact in which nip N is formed. If nip N is in a state of pressure contact (step S102: YES), pressure contact release motor M1 is rotated for a predetermined period of time, so as to release nip N of fixing section 30 (step S103), and the control of halogen heater TH1 is initiated (step S104), and halogen heater HT1 is activated as appropriate so as to heat fixing belt 31 to a predetermined temperature (step S105). As the predetermined temperature, a temperature which is equivalent to the temperature during the copying operation is preferred (namely, 160 to 200° C.), or a temperature higher than the temperature during the copying operation, the temperature which is set for fixing belt cleaning temperature (200 to 220° C.).

Note that, a fixing drive system, which is not illustrated, is activated simultaneously so as to equalize the temperature of the entire circumference of fixing belt 31.

When fixing belt 31 has reached the predetermined temperature (step S105: YES), the first sheet of sheet of paper P1 is fed from paper feed cassette 21 (step S106), which has been determined at step S101, to be conveyed to fixing section 30 via sheet transfer section Lt. Note that the first sheet of paper P1 is a blank sheet of paper, on which no toner image has been formed.

Step S107 is a step to determine whether or not a predetermined period of time Hp has elapsed from the point at which the first sheet of paper P1 has activated registration roller 27 of feeding section 20. When the predetermined period of time Hp has elapsed, the flow advances to step S108.

Step S108 is a step to form nip N of fixing section 30 by rotating pressure contact release motor M1 for a predetermined period of time. In this step, any toner stain on fixing belt 31 is transferred onto the first sheet of paper P1, whereby, the surface of fixing belt 31 is cleaned.

The predetermined period of time Hp is determined to be a longer period of time than period of time Hn which is necessary to convey sheet of paper P from registration roller 27 until the most downstream area of nip N in the direction in which a sheet of paper passes through (Hp>Hn), and after the leading edge of the first sheet of paper P1 has passed through nip N of fixing section 30, the state of outer pressure roller 33 of fixing section 30 is switched to a state of pressure contact.

Therefore, the situation is avoided, in which the leading edge of the first sheet of paper P1 is in touch with the area of toner stain on fixing belt 31, and the leading edge of the sheet, which has been fed for cleaning purpose, is separated reliably, and as a consequence, the surface of fixing belt 31 can be cleaned without paper wrapping.

Step S109 is a step to feed a second sheet of paper onwards from feeding section 20, and convey the sheet of paper to fixing section 30. Although it is basically possible to sufficiently clean the surface of fixing belt by the first sheet of paper P1 only, in the embodiment of the present invention, steps S109 and S110 added, in which a plurality of member of sheet of papers are fed and conveyed in consideration of certainty.

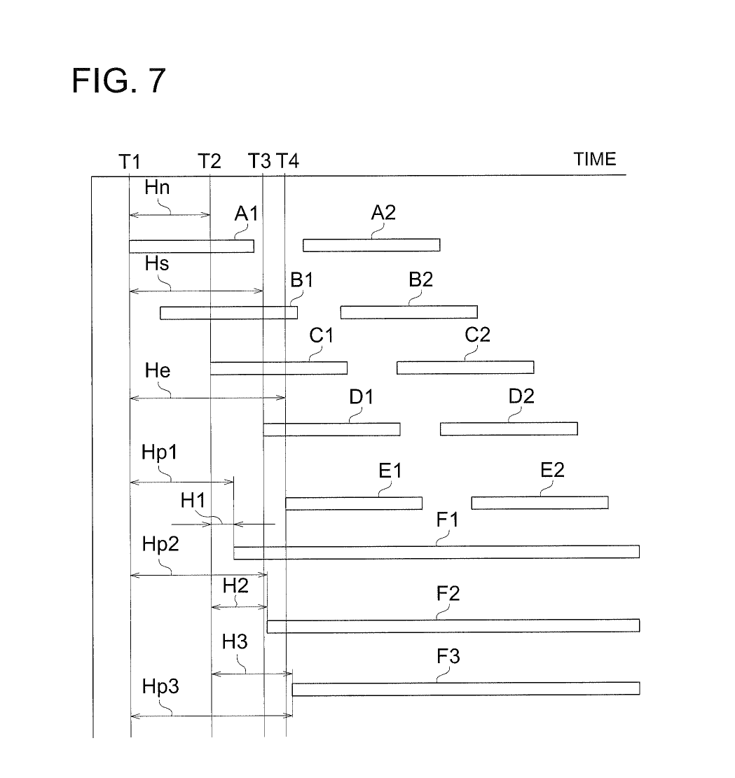

FIG. 7 is a state diagram schematically showing time frame for blank sheet of paper P to pass through the principle parts of fixing section 30 and the ON time of pressure contact mechanism to form nip N, in a case in which “fixing belt cleaning control” is carried out.

Here, two sheets of paper P, including the first sheet of paper P1 and the second sheet of paper P2, are fed as blank sheets of paper in order to clean fixing belt 31.

The transverse axis of the diagram of FIG. 7 indicates time. The reference symbol T1, illustrated in the diagram, denotes a point of time when registration roller 27 is activated and sheet of paper P is fed again toward sheet transfer section Lt. Reference symbol T2 denotes a point of time when the leading edge of sheet of paper P has reached the most downstream area of nip N, which is released, of fixing section 30 in the direction in which a sheet of paper passes through. Reference symbol T3 denotes a point of time when the leading edge of sheet of paper P has reached the most upstream area of separation facilitating section 40 in the direction in which a sheet of paper passes through (the most downstream area of Lb, in FIG. 2, in the direction in which a sheet of paper passes through). Reference symbol T4 denotes a point of time when the leading edge of sheet of paper P has reached the nip of fixing section ejection rollers 35 (the most downstream area of Lr, in FIG. 2, in the direction in which a sheet of paper passes through).

Therefore, reference symbol Hn denotes the time necessary for the leading edge of sheet of paper P to pass through from registration roller 27 until nip N of fixing section 30, and reference symbol Hs denotes the time necessary for the leading edge of sheet of paper P to pass through from registration roller 27 until fixing section ejection rollers 35. Reference symbol He denotes the time necessary for the leading edge of sheet of paper P to pass from registration roller 27 until fixing section ejection rollers 35. The relationship of expression Hn<Hs<He holds true among Hn, Hs, and He.

Reference symbols A1 and A2, illustrated in FIG. 7, denote the time necessary for sheets of paper P1 and P2 to pass through registration roller 27. Similarly, reference symbols B1 and B2 denote the time necessary for sheets of paper P1 and P2 to pass through sheet transfer section Lt, the reference symbols C1 and C2 denote the time necessary for sheets of paper P1 and P2 to pass through nip N, reference symbols D1 and D2 denote the time necessary for sheets of paper P1 and P2 to pass through separation facilitating section 40, and reference symbols E1 and E2 denote the time necessary for sheets of paper P1 and P2 to pass through fixing section ejection rollers 35.

Reference symbols F1, F2, and F3, illustrated in FIG. 7, denote three kinds of typical examples of the preferred embodiment of the present invention, but not limited to, regarding the timing of nip formation.

In the case of the first example shown by F1, pressure contact release mechanism 34 is activated to the state of pressure contact at the point of time when first time Hp1 elapsed from T1, and first time Hp1 is in the range of Hn<Hp 1.

Next, in the case of the second example shown by F2, pressure contact release mechanism 34 is activated to the state of pressure contact at the point of time when second time Hp2 elapsed from T1, and second time Hp2 is in the range of Hs<Hp2.

Also, in the case of the third example shown by F3, pressure contact release mechanism 34 is activated to the state of pressure contact at the point of time when third time Hp3 elapsed from T1, and third time Hp3 is in the range of Hs<Hp3.

Reference symbols H1, H2, and H3 each corresponds to the elapsed time from the time when the leading edge of sheet of paper P passes through the area corresponding to nip N, until the time when nip N is formed in the timings of nip formation in the first to third examples. In other words, H1, H2, and H3 each corresponds to the length of the leading edge area of sheet of paper P where pressure contact by fixing belt 31 has no affect.

As for the length of leading edge area Pfa of a sheet of paper, in the direction in which a sheet of paper is conveyed, in the timing of nip formation in the first to third examples, if the conveyance speed of sheet of paper P is set to Vp, then the relationship of expressions such as Vp×H1, Vp×H2, and Vp×H3 hold true. Conveyance speed Vp is preferably equal to a slowest speed in cases in which there are a plurality of conveyance speeds in accordance with the weight of a sheet of paper during normal copying operation, or slower than the speed of normal copying operation which has been set for fixing belt cleaning control, as an example, ½ to ⅓ of normal conveyance speed. By slowing the conveyance speed, the passage of sheet of paper P, to pass through nip N, becomes longer, and therefore, the toner stain on fixing belt 31 can be transferred (cleaned off) more definitely onto sheet of paper P.

Paper wrapping of sheet of paper P, around fixing belt 31, can be prevented from occurring by controlling pressure contact release mechanism 34 so that nip N of fixing section 30 is formed after the leading edge of a sheet of paper passed though nip N so as to assuredly avoid a situation in which the leading edge area Pfa of a sheet of paper is adhered to stray toner on fixing belt 31. The amount of protrusion of the leading edge of sheet of paper P from nip N, was preferably more than or equal to 20 mm. When the protrusion was less than 20 mm, a case existed in which sheet of paper P could not be separated from fixing belt 31, and was wrapped around fixing belt 31. This situation corresponds to the timing of nip formation according to the first example, which has been described previously. To make the length of the leading edge area Pfa of a sheet of paper, in the direction in which a sheet of paper is conveyed, in this example, more than 20 mm, elapsed time H1 is set so that expression Vp×H1≧20 mm holds true for elapsed time H1 from the time when the leading edge of sheet of paper P passes through the area corresponding to nip N, until the time when nip N is formed.

Further, more preferable timing of nip formation, for more assured paper wrapping prevention, is, as an example but not limited to, the timing of nip formation in the second example, previously described, in which nip N of fixing section 30 is formed after the leading edge of sheet of paper P has passed through the most upstream area Lb of separation facilitating section 40 in the direction in which a sheet of paper is conveyed. In this example, because the leading edge of sheet of paper P has passed through the most upstream area Lb of separation facilitating section 40 in the direction in which a sheet of paper is conveyed, even if sheet of paper P tends to wrap around fixing belt 31, sheet of paper P can be separated from fixing belt 31 assuredly via separation facilitating section 40, because the leading edge of sheet of paper P is on the downstream side of separation facilitating section 40. To make the length of the leading edge area Pfa of a sheet of paper more than Lb, in the direction in which a sheet of paper is conveyed, elapsed time H2 is set so that the expression Vp×H2≧Lb holds true for elapsed time H2 from the time when the leading edge of sheet of paper P passes through the area corresponding to nip N, until the time when nip N is formed.

A most preferable timing of pressure contact is, as an example but not limited to, the timing of nip formation of the third example, previously described, in which nip N of fixing section 30 is formed after the leading edge of sheet of paper P has been sandwiched between fixing section ejection rollers 35. In this example, because the leading edge of sheet of paper P has been sandwiched between fixing section ejection rollers 35, even if sheet of paper P tends to wrap around fixing belt 31, sheet of paper P can be separated from fixing belt 31 assuredly via separation facilitating section 40 because sheet of paper P can be pulled out by fixing section ejection rollers 35. To make the length of the leading edge area Pfa of a sheet of paper more than Lr, in the direction in which a sheet of paper is conveyed, in this example, elapsed time H3 is set so that the expression Vp×H3≧Lr holds true for elapsed time H3 from the time when the leading edge of sheet of paper P passes through the area corresponding to nip N, until the time when nip N is formed.

As described above, a fixing member cleaning control, according to the first embodiment of the present invention, is capable of providing an image forming apparatus, in which nip P is formed after the leading edge area Pfa of a sheet of paper has already passed nip P, which has been released, so that a paper wrapping is prevented from occurring, and also the apparatus is capable of cleaning the fixing belt, as a fixing member, by conveying a blank sheet of paper.

### Second Embodiment

Next, a second preferred embodiment of the present invention, according to fixing member cleaning control, will be described.

The second embodiment is applicable to image forming apparatus A which is not equipped with pressure contact release mechanism 34 which functions to press nip N, of fixing section 30, into contact or to release it.

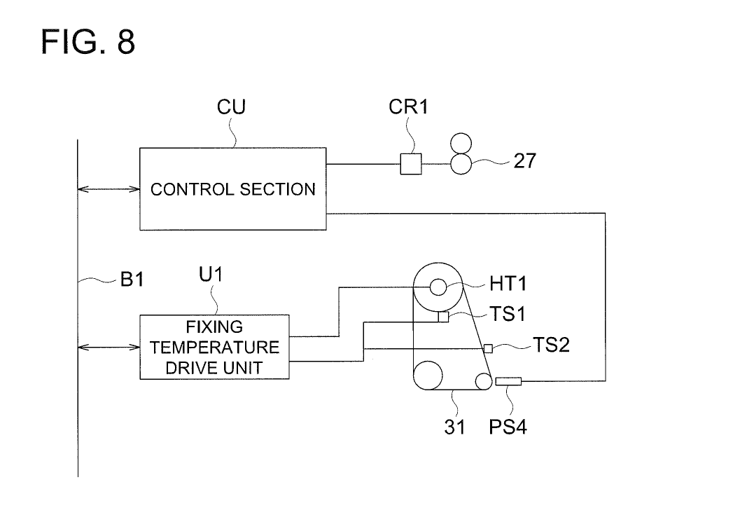

FIG. 8 is a block diagram schematically showing a control mechanism for fixing belt cleaning according to the second embodiment. Reference symbol PS4 denotes image sensors PS4, each of which is disposed at such position that is opposite to fixing belt 31, as a toner amount detection means, to detect a reflection density which corresponds to the amount of toner on many a region of fixing belt 31 in the width direction perpendicular to the rotational direction of fixing belt 31.

Some of image sensors PS4 detect a pattern which shows the circumferential position of fixing belt 31, the pattern which is printed on one end of fixing belt 31, and also, on a non-toner stain area, and also detect a reflection density of each of plural areas in the width direction of fixing belt 31. The detected signals of image sensors PS4 are inputted to an input section of control section CU.

Therefore, control section CU determines an area, on fixing belt 31, where there is a possibility of paper wrapping, based on signals of image sensors PS4 (pattern detection, optical density detection) by rotating fixing belt 31 at a predetermined speed. Also, control section CU determines whether or not a toner stain, which is at a level necessary to activate the fixing member cleaning control, occurs on fixing belt 31 immediately after a paper jam occurs.

Because pressure contact release mechanism 34 is not a mechanism which functions automatically, but relies on manual manipulation mechanism after jam treatment, it is omitted in this embodiment.

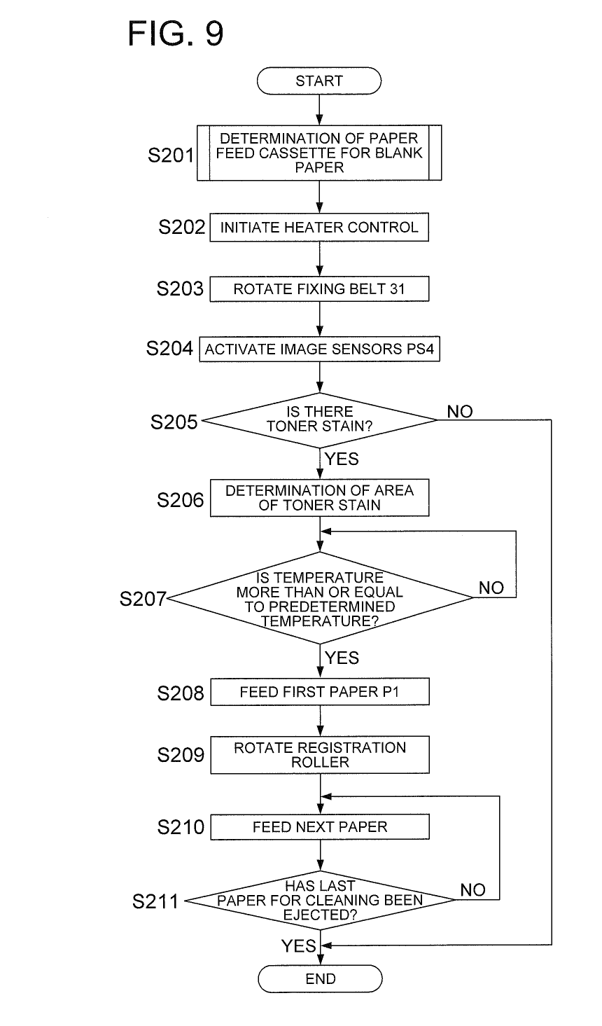

FIG. 9 is a flow chart showing a fixing member cleaning control according to a second embodiment of the present invention.

Step S201 is a step to determine an appropriate paper feed cassette 21, similar to step S101 in FIG. 6. An example of step S201 will be described later.

A heater control is initiated at step S202, fixing belt 31 is rotated at step S203, and image sensor PS4 is activated at step S204.

Step S205 is a step to determine, based on a detected signal from image sensor PS4, whether or not the level of toner stain on fixing belt 31 is one at which the fixing member cleaning control is to be activated. If there is a toner stain of that level (step S205: YES), the flow advances to step S206, and fixing member cleaning control is complete.

Step S206 is a step to determine, based on a detected signal from image sensor PS4, non-toner stain region Rn on fixing belt 31, where there is little risk of paper wrapping.

Step S207 is a step to determine whether or not the temperature of fixing belt 31 is within the range of a predetermined temperature, and if the temperature is within that range of the predetermined temperature, the flow advances to step S208.

Note that the range of the predetermined temperature is a range of temperature at which any toner on fixing belt 31 is completely transferred onto sheet of paper P when fixing belt 31 is pressed into contact with sheet of paper P at nip N.

Step S208 is a step to feed the first sheet of paper P1 to registration roller 27.

Step S209 is a step to convey the first sheet of paper P1 by rotating registration roller 27 at a timing by which the leading edge area Pfa of a sheet of paper falls inside non-toner stain region Rn on fixing belt 31 at nip N.

Note that the length of the leading edge area Pfa of a sheet of paper is more than or equal to the length between the most downstream area of nip N, in the direction in which a sheet of paper is conveyed, and sheet transfer separation section Ls. Preferably, it is more than or equal to the length between the most downstream area of nip N, in the direction in which a sheet of paper is conveyed, and fixing section ejection rollers 35.

A most outstanding effect in paper wrapping prevention is obtained by setting the timing to initiate the rotation of registration roller 27 so as to maximize the length of the leading edge area Pfa of a sheet of paper, in a direction in which sheet of paper is conveyed, including the leading edge, the length of the leading edge area Pfa which falls inside non-toner stain region Rn.

Steps S210 and S211 are feed/conveyance steps of a sheet of paper after the first sheet of paper P1 onwards.

As described above, a fixing member cleaning control mechanism, according to the second embodiment of the present invention, is capable of providing an image forming apparatus, capable of cleaning a fixing belt as a fixing member without paper wrapping, via feeding of a blank sheet of paper by conveying sheet of paper P at a timing so that the leading edge area Pfa of a sheet of paper falls inside non-toner stain region Rn on fixing belt at nip N.

Next, a control mechanism, to determine the type of sheet of paper P to be used for blank sheet of paper feeding for fixing member cleaning control, will be described.

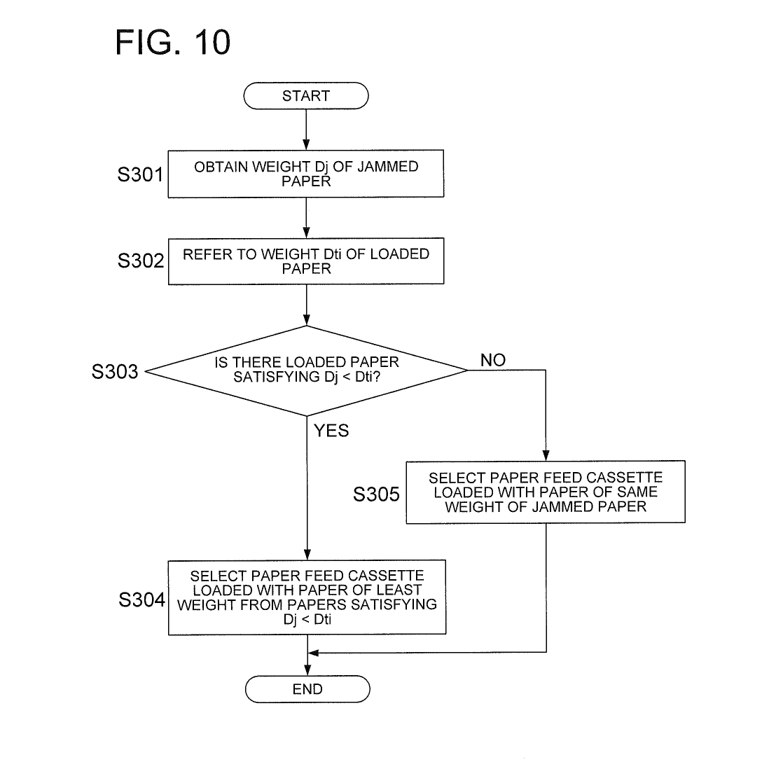

FIG. 10 is a flow chart showing a control mechanism to determine the paper feed cassette to be used for blank sheet of paper feeding, and corresponds to step S101 in FIG. 6 and step S201 in FIG. 9.

Step S301 is a step to obtain the weight of sheet of paper P used for image formation before fixing member cleaning is executed, namely, step S301 is a step to obtain weight Dj of the jammed sheet.

Step S302 is a step to refer to weight Dtj of a sheet of paper which is loaded into each of three paper feed cassettes 21 of feed section 20 of image forming apparatus A.

Step S303 is a step to determine whether paper feed cassette 21, into which a heavier weight paper than the jammed paper is loaded, exists or not. In the case of YES (in the case of existence of a heavier weight paper), paper feed cassette 21, into which the least heavier weight paper, among the heavier weight papers, is loaded, is determined as the paper feed cassette for blank sheet of paper feeding (step S304). In the case of NO (in the case of non-existence of heavier weight paper), a paper feed cassette, into which the same paper of the jammed paper is loaded, is selected, and blank paper feeding is carried out (Step S305).

As stated above, prevention performance of paper wrapping is improved further by carrying out blank sheet of paper feeding by using a paper which is heavier than the jammed paper on which image formation was carried out most recently.

Note that, although fixing belt 31 is used as a fixing member in the first and second embodiments, a fixing roller is also applicable, and is within the scope of the present invention.

Further, “fixing belt cleaning control” according to the first and second embodiments is applicable to cases in which toner is adhered to a fixing section for some reason other than a paper jam, for example, due to a failure of other mechanical sections in a state in which fixing is incomplete, or the like, and an image forming apparatus, which is equipped with “fixing belt cleaning control” like this, is within the scope of the present invention.

Although the present invention has been fully described by way of examples with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming apparatus comprising:
an image forming section for forming a toner image on a sheet of paper, a feeding section for feeding a sheet of paper to said image forming section;
a fixing section for fixing a toner image onto a sheet of paper by sandwiching and conveying the sheet of paper, onto which a toner image has been formed, at a nip which is formed between a fixing member and a pressure member which is pressed into contact with said fixing member; and
a control section for controlling, in a case in which an image is formed on a sheet of paper, said feeding section, said image forming section, and said fixing section so as to feed a sheet of paper from said feeding section, to form a toner image on the sheet of paper via said image forming section, and to fix the toner image on the sheet of paper via said fixing section,
wherein, in a case in which a toner is adhered to a fixing section without complete fixing of a toner image onto a sheet of paper, said control section is configured to control to feed a sheet of paper from said feeding section, and convey said sheet of paper to said fixing section without forming a toner image on said sheet of paper via said image foaming section, and transfer the toner, having been adhered onto said fixing member, onto a downstream side of said sheet of paper from a leading edge area of said sheet of paper in a direction in which a sheet of paper is conveyed.

2. The image forming apparatus described in claim 1, wherein an operation to transfer a toner, having been adhered onto said fixing member, is carried out in a case in which a recovery operation, after jamming of a sheet of paper, is carried out.

3. The image forming apparatus described in claim 1, further comprising a pressure contact release mechanism for forming or releasing said nip, wherein said control section is configured to control said pressure contact release mechanism so as to form said nip after the leading edge area of said sheet of paper has passed through said nip which has been released.

4. The image forming apparatus described in claim 3, further comprising a separation facilitating member, which is located in a downstream side of said nip in a rotational direction of said fixing member, for facilitating a separation of a sheet of paper from said fixing member, wherein said control section is configured to control to form said nip after the leading edge area of said sheet of paper has passed through said separation facilitating member.

5. The image forming apparatus described in claim 3, further comprising a fixed sheet discharge roller, which is disposed in a downstream side of said nip in the direction in which a sheet of paper is conveyed, for conveying a sheet of paper toward said downstream side, wherein said control section is configured to control to form said nip after the leading edge area of said sheet of paper has passed through said separation facilitating member.

6. The image forming apparatus described in claim 1, further comprising a toner amount detection section, which is disposed at such position that is opposite to said fixing member, for detecting a toner amount on said fixing member, wherein said control section is configured to control, after having determined a non-toner stain area in a rotational direction of said fixing member based on a signal of said toner amount detection section, to convey a sheet of paper so that the leading edge area of said sheet of paper falls inside said non-toner stain area.

7. The image forming apparatus described in claim 6, wherein said control section is configured to control to convey a sheet of paper so as to maximize the leading edge area of said sheet of paper in terms of length in the direction in which a sheet of paper is conveyed.

8. The image forming apparatus described in claim 1, wherein said control section is configured to control, in a case in which a recovery operation, after jamming of a sheet of paper, has been carried out, to feed a sheet of paper of heavier weight than that of a sheet of paper, having been fed for image formation from said feeding section before an occurrence of paper jam.

9. A cleaning method of an image forming apparatus, the apparatus comprising:
an image forming section for forming a toner image on a sheet of paper;
a feeding section for feeding a sheet of paper to said image forming section;
a fixing section for fixing a toner image on a sheet of paper, onto which the toner image has been formed, by sandwiching and conveying the sheet of paper at a nip which is formed between a fixing member and a pressure member which is pressed into contact with said fixing member;
wherein the cleaning method comprises steps of
feeding a sheet of paper;
conveying said sheet of paper, having been fed, without carrying out image formation via said image forming section;
releasing said nip of said fixing section and passing said sheet of paper through; and
forming said nip after a leading edge of said sheet of paper has passed though said fixing section, and sandwiching and conveying said sheet of paper via said nip, having been formed.

10. The cleaning method described in claim 9, wherein said cleaning is carried out in a case in which a recovery operation after jamming of a sheet of paper is carried out.

11. The cleaning method described in claim 10, wherein said step for feeding a sheet of paper is to feed a heavier weight of sheet of paper than that of a sheet of paper, which has been fed for image formation before an occurrence of paper jam, from said feeding section.

12. The cleaning method described in claim 9, the method further comprising a step of detecting a toner amount on said fixing member,
wherein said step of conveying comprises steps of:
determining a non-toner stain area in a rotational direction of said fixing member based on said detected toner amount; and
controlling to convey a sheet of paper so that a leading edge area of said sheet of paper falls inside said non-toner stain area.
